(19) United States
(12) Patent Application Publication
(10) Pub. No.: US 2026/0210155 A1
(43) Pub. Date: Jul. 23, 2026

(54) MAGNETICALLY RELEASED LOCK ASSEMBLY

(71) Applicant: YONDR, INC., Los Angeles, CA (US)

(72) Inventors: Anthony ABDELMALEK, Laguna Hills, CA (US); Shi-Shuang CHEN, Tainan City (TW); Chun-Li WANG, Taipei (TW)

(21) Appl. No.: 19/027,139

(22) Filed: Jan. 17, 2025

(51) Int. Cl. E05B 15/00; E05B 15/04

(52) U.S. Cl. CPC E05B 15/0073; E05B 15/04

(57) ABSTRACT

The disclosure is directed to a lock assembly comprising an upper body, a lower body, a post, post bearings, a bearing housing, and/or a bearing guide. The post is configured to couple the upper body to the lower body in a locked state. The lower body houses a bearing guide, bearing housing, and post bearings, with the bearings positioned inside the bearing housing. The bearing guide includes a tapered inner surface, controlling the lateral movement of the post bearings. A bearing housing spring forces the bearing housing against the top inner surface of the bearing guide, engaging the post neck when locked. The upper body includes an upper cover frame and a post housing, which guides the vertical motion of the post. Magnetic forces control engagement and disengagement of the post, allowing the lock to be unlocked by drawing the bearing housing downward.

### FIELD OF THE DISCLOSURE

The disclosure relates to a lock assembly. More particularly, the disclosure is directed to a lock assembly that uses magnetic force to disengage post bearings from a post.

### SUMMARY OF THE DISCLOSURE

The disclosure is directed to a lock assembly that includes an upper body, a lower body, a post, one or more post bearings, a bearing housing, and a bearing guide. The post is configured to couple the upper body to the lower body in a locked state. Within the lower body, a bearing guide, bearing housing, and one or more post bearings are housed, with the bearings positioned inside the bearing housing. The bearing housing facilitates the lateral movement of the post bearings, which is controlled by the bearing guide.

The bearing guide features a tapered inner surface, allowing the bearing housing to travel along its length. This tapered surface controls the lateral distance the post bearings can travel, enabling the post to pass between them when the bearing housing is in a lower portion of the bearing guide. A bearing housing spring forces the bearing housing against the top inner surface of the bearing guide, causing the post bearings to engage the post neck when the lock is in a locked state.

The upper body of the assembly includes an upper cover frame and an upper cover, which is coupled to the frame. The upper cover contains a post housing, positioned within the frame and guided by a post housing guide. The vertical motion of the post housing is designed to cause a corresponding vertical motion of the post, with the post housing spring forcing the post housing out of the top of the upper cover when unlocked.

The post housing spring pushes the post housing upward when the lock assembly is in an unlocked state, causing the post to be retracted into the upper body. The post bearings prevent upward motion of the post by the post housing spring when in a locked state. The bearing housing and post bearings are configured to move in response to magnetic forces, allowing for controlled engagement and disengagement of the post. To unlock the assembly, a magnetic force is applied to draw the bearing housing downward, allowing the post bearings to disengage from the post neck.

### DESCRIPTIONS OF THE DRAWINGS

The features and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 illustrates a post housing in accordance with some embodiments of the present disclosure;

FIG. 2 shows a housing cap in accordance with some embodiments of the present disclosure;

FIG. 3 depicts a bottom view of the post housing in accordance with some embodiments of the present disclosure;

FIG. 4 shows an assembled view of the cap and housing in accordance with some embodiments of the present disclosure;

FIG. 5 illustrates an upper cover in accordance with some embodiments of the present disclosure;

FIG. 6 depicts a bottom view of the upper cover in accordance with some embodiments of the present disclosure;

FIG. 7 illustrates an assembled view of the upper cover in accordance with some embodiments of the present disclosure;

FIG. 8 shows a bottom of the assembled view of the upper cover in accordance with some embodiments of the present disclosure;

FIG. 9 shows details of the upper body in accordance with some embodiments of the present disclosure;

FIG. 10 illustrates the upper cover assembled to the upper body in accordance with some embodiments of the present disclosure;

FIG. 11 depicts a bottom view of the upper body in accordance with some embodiments of the present disclosure;

FIG. 12 illustrates details of the post in accordance with some embodiments of the present disclosure;

FIG. 13 shows the post and post bearings in accordance with some embodiments of the present disclosure;

FIG. 14 illustrates the post bearings within the bearing housing in accordance with some embodiments of the present disclosure;

FIG. 15 shows the bearing guide covering the bearing housing in accordance with some embodiments of the present disclosure;

FIG. 16 shows details of the post assembly in accordance with some embodiments of the present disclosure;

FIG. 17 illustrates the lower body in accordance with some embodiments of the present disclosure;

FIG. 18 depicts the lower cover in accordance with some embodiments of the present disclosure;

FIG. 19 illustrates the lower cover assembled to the lower body in accordance with some embodiments of the present disclosure;

FIG. 20 shows an assembled view of the lock assembly in accordance with some embodiments of the present disclosure;

FIG. 21 illustrates a top view of the lock assembly in accordance with some embodiments of the present disclosure;

FIG. 22 depicts a bottom view of the lock assembly in accordance with some embodiments of the present disclosure;

FIG. 23 depicts a half-moon upper body in accordance with some embodiments of the present disclosure; and

FIG. 24 illustrates half-moon lower body in accordance with some embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment and phrases such as “in another embodiment” or “in various embodiments” as used herein does not necessarily refer to a different embodiment. It is intended, for example, that claimed subject matter include combinations of example embodiments shown in the figures, in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

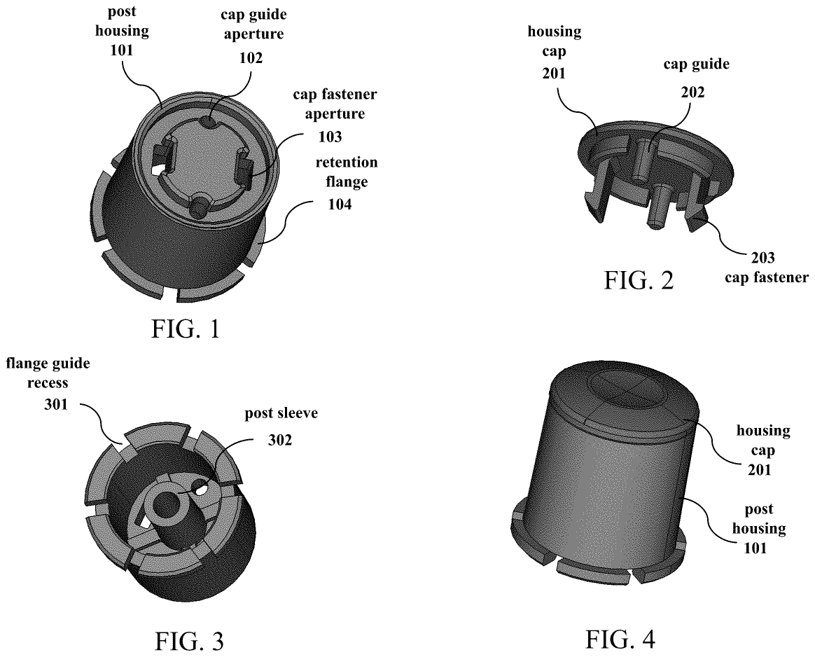

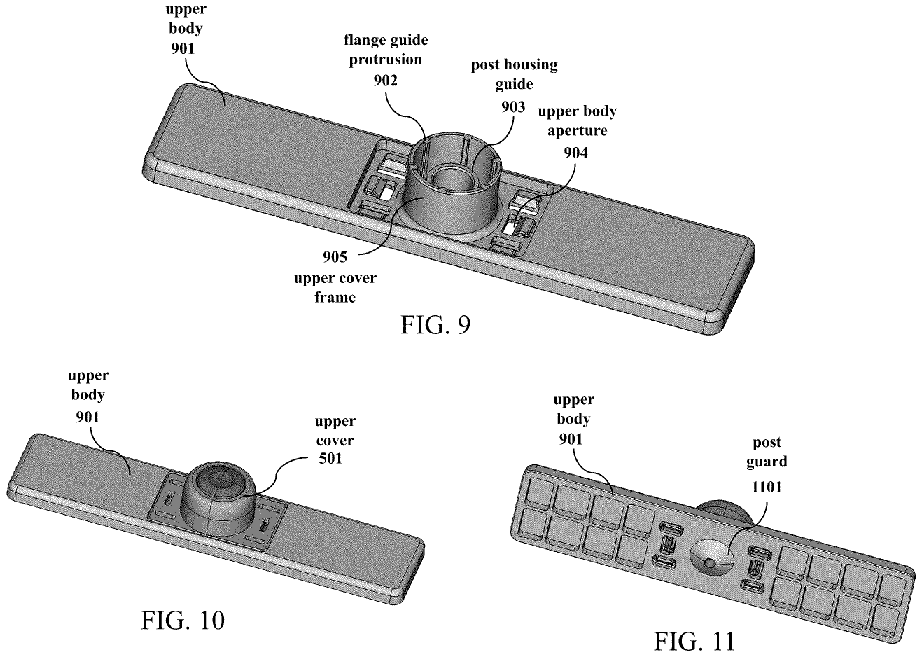

Certain embodiments and principles of the lock assembly 2000 will be discussed in more detail with reference to the figures. In accordance with some embodiments, FIG. 1 depicts a post housing 101 configured to couple to the housing cap 201 shown in FIG. 2. In some embodiments, the post housing 101 includes one or more cap fastener apertures 103 configured to engage a respective cap fastener 203, where the proper alignment of the post housing 101 and the housing cap 201 is facilitated by one or more cap guides 202 configured for fitted insertion into a respective cap guide aperture 102. A bottom portion of the post housing 101 includes a retention flange 104 that include one or more flange guide recesses 301 as illustrated in FIG. 3, which engage a respective flange guide protrusion 902, best shown in FIG. 9. The post sleeve 302 aligns the post 1201 when assembled. FIG. 4 shows an assembled view of the housing cap 201 coupled to the post housing 101 in accordance with some embodiments.

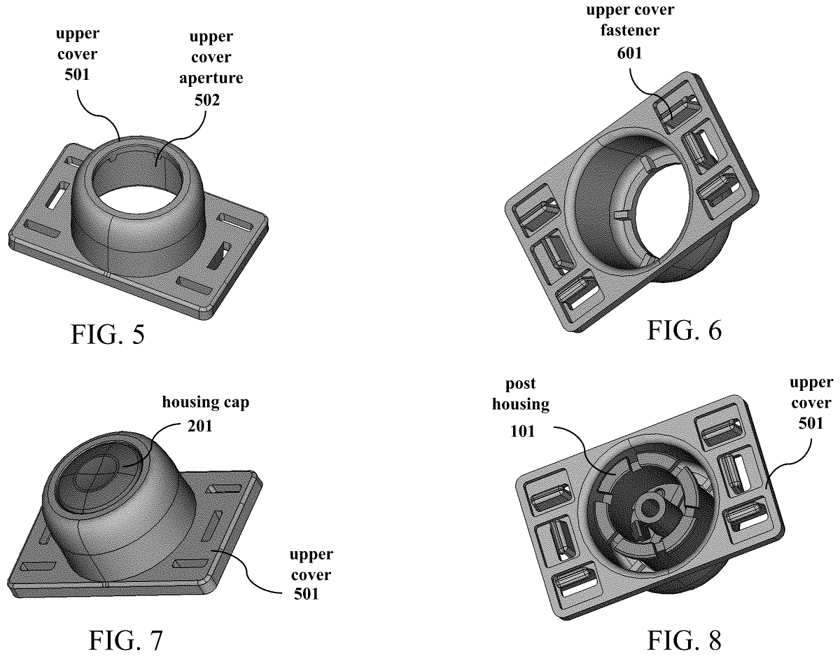

Turning now to FIG. 5, in some embodiments, the lock assembly 2000 includes an upper cover 501 with an upper cover aperture 502 configured to cooperate with the post housing 101 to guide the post 1201 in a downward direction as described further infra. In some embodiments, the upper cover 501 includes one or more upper cover fasteners 601, as shown in FIG. 6, configured to engage a respective upper body aperture 904 (FIG. 9) to secure the upper cover 501 to the upper body 901 as shown in FIG. 10. When assembled, the post housing cap 201 is visible and/or accessible from above as depicted in FIG. 7, and is coupled to the post housing 101 forming the assembly shown in FIG. 8.

Turning back to FIG. 9, the assembly of FIG. 8 is configured to be coupled to the upper surface of the upper body 901 of the lock assembly 2000. The post housing 101 is positioned between the upper cover frame 905 and the post housing guide 903 when assembled, where the post housing 101 is prevented from rotation by a flange guide protrusion 902 engaging a respective flange guide recess 301. As shown in FIG. 11, a lower surface of the upper body 901 includes a post guard 1101 configured to prevent manipulation of the post 1201 when the lock assembly 2000 is in a locked state.

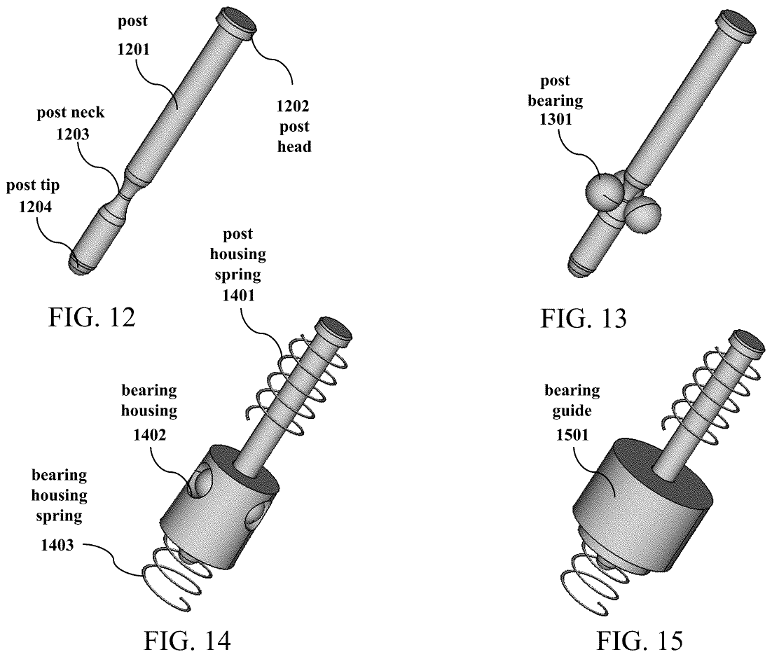

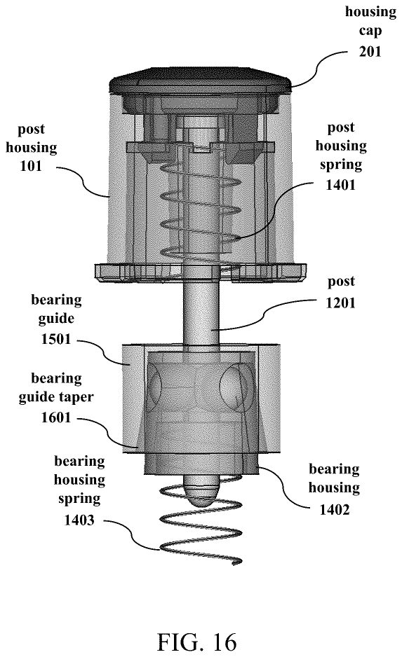

Details of the post assembly components are shown in FIGS. 12-16. The post 1201 includes a post head 1202 configured to be housed in the post sleeve 302. The post 1201 also includes a post neck 1203 configured to engage one or more post bearings 1301 that are housed within a bearing housing 1402. In some embodiments, the post 1201 is approximately 2.5 mm in diameter, and/or may be manufactured by lathe, which allows for sharper corners in the neck region to better hold the post bearings 1301. The bearing housing 1402, which may also be manufactured using a lathe, is configured to engage a bearing housing spring 1403 which forces the bearing housing 1402 up into the bearing guide 1501 when not acted upon by a magnetic force. In some embodiments, the mass of each of the post bearings 1301 is selected to not allow the bearing housing 1402 to move against the force of the bearing housing spring 1403 when slammed against a hard surface. The bearing housing spring 1403, in some embodiments, includes an approximately 0.06 mm outer diameter, with a distance between spring coils configured to prevent downward travel of the spring resulting from impact against a hard surface.

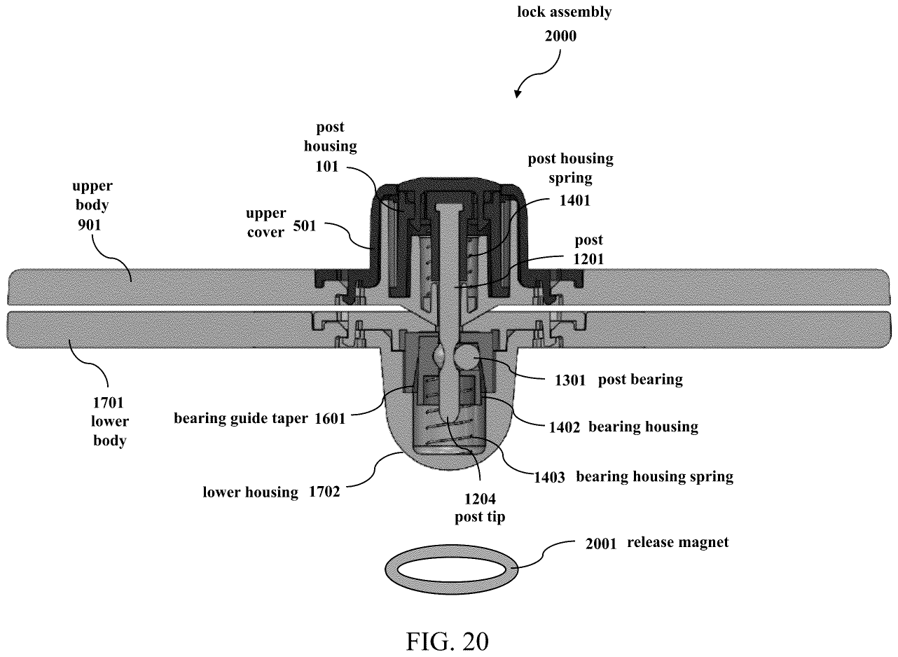

In some embodiments, the post housing spring 1401 forces the post housing 101, as well as the post 1201, upward and through the upper cover aperture when the one or more post bearings 1301 are separated from the post neck 1203 when the bearing housing 1402 is moved down by magnetic force. In some embodiments, the magnetic force of the release magnet 2001 must be greater or equal to 10,000 gauss, eliminating open market magnets from being able to pull the bearing housing 1402 down to unlock the lock assembly 2000. In some embodiments, the bearing guide 1501 includes a bearing guide taper 1601, which may be formed by a lathe, which controls lateral movement of the one or more bearings away from the post neck 1203 as the bearing housing 1402 is moved downward, which is described further with reference to FIG. 20.

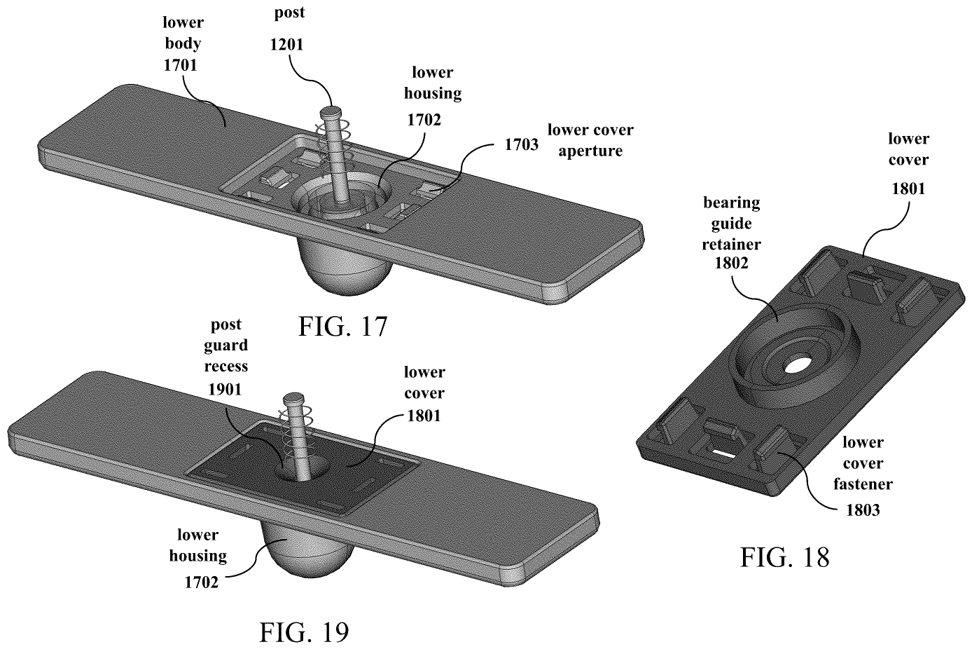

Turning now to FIG. 17, the lower body 1701 includes a lower housing 1702 configured to prevent access to the bearing guide 1501 and bearing housing 1402. In some embodiments, the lower body 1701 includes one or more lower cover apertures 1703 configured to engage a respective lower cover fastener 1803 on the lower cover 1801 depicted in FIG. 18. In some embodiments, the lower cover 1801 includes a bearing guide retainer 1802 configured to hold the bearing guide 1501 in a center position within the lower housing 1702 when assembled. As shown in FIG. 19, when assembled to the lower body 1701, a post guard recess 1901 formed in the lower cover 1801 is configured to mate with the post guard 1101 illustrated in FIG. 11, such that post 1201 is protected through the gap formed when the upper body 901 and lower body 1701 are brought together, as shown in FIG. 20.

Still referring to FIG. 20, an assembled view of the lock assembly 2000 is depicted in accordance with some embodiments. The upper body 901 and lower body 1701 are configured to couple to respective portions of a container opening, such as flaps of a pouch, where the upper body 901 and lower body 1701 close cooperate to close the container opening when brought into engagement. When in an unlocked state, the post housing 101 protrudes from the upper cover 501 as the post housing 101 is forced up by the post housing spring 1401. In this state, a majority of the post 1201 is contained within the upper body 901. When the user wishes to lock the container, the user pressed the post housing 101 down against the force of the post housing spring 1401 driving the post 1201 into engagement with the post bearings 1301 within the bearing housing 1402.

As the bearing housing 1402 is initially pressed against the top of the bearing guide 1501, the bearing guide taper 1601 prevents lateral travel of the one or more post bearings 1301. Instead, the bearing housing 1402 is forced downward by the post 1201 against the force of the bearing housing spring 1403 until the bearing guide taper 1601 enables sufficient lateral travel of the one or more post bearings 1301 to allow the post tip 1204 to pass by. As the post neck 1203 enters the bearing housing 1402 the reduced cross-section provides room for the post bearings 1301 to travel back laterally toward the post neck 1203, which also allows the bearing housing 1402 to be pushed back into the narrowest portion of the bearing guide taper 1601, locking the post 1201 in a fixed position. The structure of the post housing 101 prevents any further downward motion of the post 1201, while the post bearings 1301 prevent upward motion of the post 1201 by the post housing spring 1401.

In some embodiments, the post bearings 1301 and/or bearing housing 1402 are configured to be moved by magnetic force, where one or more of the post bearings 1301, the bearing housing 1402, and/or the bearing housing spring 1403 may include magnet and/or ferromagnetic material. Upon exposing the lower housing 1702 to a release magnet 2001 of sufficient strength, the bearing housing 1402 is moved down within the lower housing 1702, where the curvature of the post neck 1203 is configured to enable lateral movement of the post bearings 1301 along the bearing guide taper 1601 until the post tip 1204 is able to pass through. Once there is sufficient room, the post housing spring 1401 draws the post 1201 into the upper body 901, unlocking the lock assembly 2000.

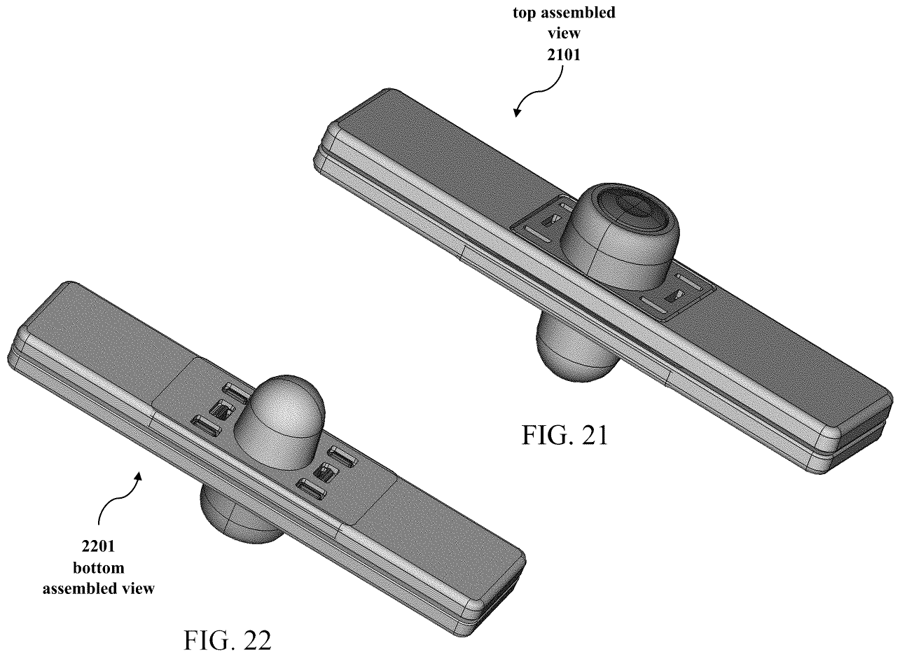

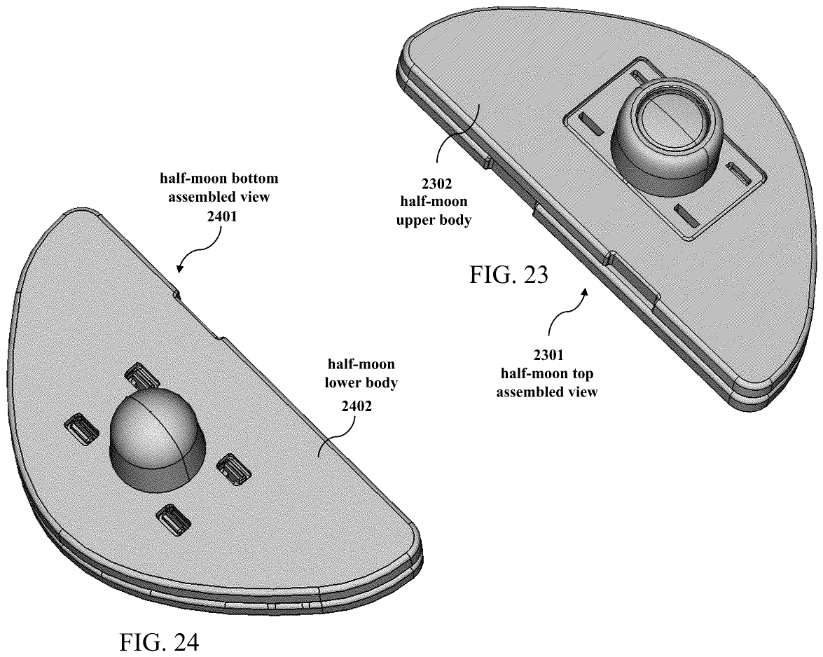

FIGS. 21 and 22 show a top assembled view 2101 and bottom assembled view 2201, respectively, of the lock assembly 2000. FIGS. 23 and 24 show a top assembled view 2301 and bottom assembled view 2401, respectively, of the lock assembly 2000 integrated into a half-moon configuration. All functionality and structures associated with FIGS. 1-22 are the same in the half-moon assembly, with the exception of the shape of the half-moon upper body 2302 and half-moon lower body 2402, which are formed to fit inside similar shaped container opening sections, and which provide a greater distance to the post 1201 from the gap formed when the two halves are locked together.

Any configuration presented herein can be described as a lock assembly comprising one or more of an upper body, a lower body, a post, one or more post bearings, a bearing housing, and/or a bearing guide. In some embodiments, the post is configured to couple the upper body to the lower body in a locked state. In some embodiments, the lower body comprises the bearing guide, the bearing housing, and the one or more post bearings. In some embodiments, the one or more post bearings are disposed within the bearing housing. In some embodiments, the bearing housing is configured to enable the one or more post bearings to travel laterally. In some embodiments, the bearing guide is configured to control a distance the one or more post bearings travel laterally.

In some embodiments, the bearing guide includes a tapered inner surface. In some embodiments, the bearing housing is configured to travel along a length of the tapered inner surface. In some embodiments, the tapered inner surface is configured to control the distance the one or more post bearings travel laterally. In some embodiments, a diameter of the tapered inner surface increases toward a bottom of the lower body. In some embodiments, downward motion of the bearing housing enables sufficient lateral travel of the one or more post bearings to enable the post to pass between the one or more post bearings.

In some embodiments, the lock assembly comprises a bearing housing spring. In some embodiments, the bearing housing spring is configured to force the bearing housing against a top inner surface of the bearing guide. In some embodiments, the one or more post bearings are configured to engage a post neck of the post when the bearing housing is forced against the top inner surface of the bearing guide. In some embodiments, the one or more post bearings are configured to disengage the post neck when the bearing housing is drawn downward against a force of the bearing housing spring. In some embodiments, a magnetic force is required to draw the bearing housing downward.

In some embodiments, the upper body includes an upper cover frame. In some embodiments, the upper body includes an upper cover coupled to the upper cover frame. In some embodiments, the upper cover includes a post housing 101. In some embodiments, the post housing 101 is disposed within the upper cover frame. In some embodiments, the upper cover frame includes a post housing guide configured to guide vertical motion of the post housing 101. In some embodiments, the vertical motion of the post housing 101 is configured to cause a vertical motion of the post. In some embodiments, the post housing guide includes a post housing spring configured to force the post housing 101 out a top of the upper cover when in an unlocked state.

It should be understood that the disclosed systems are not limited in its application to the details of construction and the arrangement of components set forth in the previous description or illustrated in the drawings. The systems and methods disclosed herein fall within the scope of numerous embodiments. The previous discussion is presented to enable a person skilled in the art to make and use the system according to some embodiments. Any portion of the structures and/or principles included in some embodiments can be applied to any and/or all embodiments, and it should be understood that features from some embodiments presented herein are combinable with other features according to some other embodiments. Thus, some embodiments of the system are not intended to be limited to what is illustrated but are to be accorded the widest scope consistent with all principles and features disclosed herein.

Some embodiments of the system are presented with specific values and/or setpoints. These values and setpoints are not intended to be limiting and are merely examples of a higher configuration versus a lower configuration and are intended as an aid for those of ordinary skill to make and use the system.

Any text in the drawings should be viewed as part of the instant disclosure and should be understood to be readily incorporable into any description of the metes and bounds of the system. Any functional language in the drawings is a reference to the system being configured to perform the recited function, and structures shown or described in the drawings are to be considered as the system comprising the structures recited therein.

Furthermore, acting as Applicant's own lexicographer, Applicant imparts the explicit meaning and/or disavow of claim scope to the following terms: “Substantially” and “approximately” when used in conjunction with a value encompass a difference of 5% or less of the same unit and/or scale of that being measured (e.g., degrees, volume, mass, distance).

It should be understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A lock assembly comprising:
an upper body,
a lower body,
a post,
one or more post bearings,
a bearing housing, and
a bearing guide;
wherein the post is configured to couple the upper body to the lower body in a locked state;
wherein the lower body comprises the bearing guide, the bearing housing, and the one or more post bearings;
wherein the one or more post bearings are disposed within the bearing housing;
wherein the bearing housing is configured to enable the one or more post bearings to travel laterally; and
wherein the bearing guide is configured to control a distance the one or more post bearings travel laterally.

2. The lock assembly of claim 1, wherein the bearing guide includes a tapered inner surface.

3. The lock assembly of claim 2, wherein the bearing housing is configured to travel along a length of the tapered inner surface.

4. The lock assembly of claim 3, wherein the tapered inner surface is configured to control the distance the one or more post bearings travel laterally.

5. The lock assembly of claim 4, wherein a diameter of the tapered inner surface increases toward a bottom of the lower body.

6. The lock assembly of claim 5, wherein downward motion of the bearing housing enables sufficient lateral travel of the one or more post bearings to enable the post to pass between the one or more post bearings.

7. The lock assembly of claim 1, further comprising a bearing housing spring.

8. The lock assembly of claim 7, wherein the bearing housing spring is configured to force the bearing housing against a top inner surface of the bearing guide.

9. The lock assembly of claim 8, wherein the one or more post bearings are configured to engage a post neck of the post when the bearing housing is forced against the top inner surface of the bearing guide.

10. The lock assembly of claim 9, wherein the one or more post bearings are configured to disengage the post neck when the bearing housing is drawn downward against a force of the bearing housing spring.

11. The lock assembly of claim 10, wherein a magnetic force is required to draw the bearing housing downward.

12. The lock assembly of claim 8, wherein the upper body includes an upper cover frame.

13. The lock assembly of claim 12, wherein the upper body includes an upper cover coupled to the upper cover frame.

14. The lock assembly of claim 13, wherein the upper cover includes a post housing.

15. The lock assembly of claim 14, wherein the post housing is disposed within the upper cover frame.

16. The lock assembly of claim 15, wherein the upper cover frame includes a post housing guide configured to guide vertical motion of the post housing.

17. The lock assembly of claim 16, wherein the vertical motion of the post housing is configured to cause a vertical motion of the post.

18. The lock assembly of claim 17, wherein the post housing guide includes a post housing spring configured to force the post housing out a top of the upper cover when in an unlocked state.

19. An Apparatus comprising:
an upper body,
a lower body,
a post,
one or more post bearings,
a bearing housing, and
a bearing guide;
wherein the post is configured to couple the upper body to the lower body in a locked state;
wherein the lower body comprises the bearing guide, the bearing housing, and the one or more post bearings;
wherein the one or more post bearings are disposed within the bearing housing.

20. The apparatus of claim 19, wherein the bearing housing is configured to enable the one or more post bearings to travel laterally; and wherein the bearing guide is configured to control a distance the one or more post bearings travel laterally.
